(19) United States
(12) Patent Application Publication
(10) Pub. No.: US 2009/0109490 A1
(43) Pub. Date: Apr. 30, 2009

(54) METHOD OF PRODUCING IMPROVED LENTICULAR IMAGES

(76) Inventors: Daniel L. Lau, Lexington, KY (US); Trebor R. Smith, Painter, VA (US)

Correspondence Address: FITCH EVEN TABIN AND FLANNERY, 120 SOUTH LASALLE STREET, SUITE 1600, CHICAGO, IL, 60603-3406, US

(21) Appl. No.: 12/295,542

(22) PCT Filed: Mar. 30, 2007
(86) PCT No.: PCT/US2007/008195

§ 371 Date: Sep. 30, 2008

Related U.S. Application Data
(63) Continuation-in-part of application No. 11/576,109.
(60) Provisional application No. 60/616,001, filed on Oct. 5, 2004.

(51) Int. Cl. H04N 1/405

(52) U.S. Cl. 358/3.06

(57) ABSTRACT

An image comprising a plurality of interlaced images is provided, the image is halftone processed according to one or more processes, and the image is printed, for example, using an inkjet printer. The image is halftone processed according a predetermined function depending at least in part on a gray scale level for a given pixel and those nearby the given pixel. The predetermined function can operate on a continuous tone version or on a printed-dot model of the image and may include a predetermined error filter where error is distributed to pixels corresponding to the same interlaced image from which the error accumulates. The image may be post-processed to arrange dots and/or shift columns of pixels to minimize overlap error or modified to include extra pixels to align the interlaced images under the lenses.

### RELATED APPLICATIONS

This application claims the benefit of the filing date of U.S. Provisional Application No. 60/788,534, filed Mar. 31, 2006, which is hereby incorporated herein by reference in its entirety; this application is also a continuation-in-part application of U.S. application Ser. No. 11/576,109, which is a National Stage of International Application No. PCT/US2005/035603, filed Oct. 5, 2005, which claims the benefit of U.S. Provisional Application No. 60/616,001, filed Oct. 5, 2004, each of which are hereby incorporated herein by reference in their entirety.

### TECHNICAL FIELD

This invention relates generally to lenticular images and more specifically to methods of halftoning continuous tone images for lenticular applications.

### BACKGROUND

Generally speaking, the process of creating lenticular images is known in the art. The term “lenticular imaging” refers to the art of interleaving images behind an array of lenses such that a viewer views different images as the viewer's angle of perception changes relative to the lenses. Typically, lenticular arrays employ several lenses arranged as columns across a set of interleaved or interlaced (also called “spatially multiplexed”) images; however, several new array configurations are known allowing a wider variety of viewing possibilities. Software applications are known that can interlace various continuous tone images into a single continuous tone lenticular image to be placed behind a lens array.

Color digital images are typically made up of a grid of pixels. These pixels have a wide range of red, green, and blue light varying from black to full brightness. The intensity or brightness of any given color is referred to as a gray scale for the color. The gray scale ranges in value from zero to one hundred, also referred to as zero to one hundred percent. For simplicity, this application will refer only to gray scale with the understanding that any single color may be reproduced using the discussed methods. Digital images of this sort are often referred to as “continuous tone” images. While this way of representing images on a computer display or television works quite well, it does not work for printed images because there is no practical way to print ink at varying levels of intensity. Unlike on-screen pixels that each can have a wide range of intensity, individual printed dots can not vary in brightness. In other words, any given spot on a printed image is either a full spot of ink or blank paper. Therefore, to make printed images fool the naked eye into seeing shades of gray and smooth tonal gradations, the continuous tone image must be processed into a form that will allow this. This process is known as halftoning or screening. The halftoning process involves the conversion of large pixels that each have varying shades of gray (from a continuous tone image) into much smaller spots that can have only back or white values (the halftoned image). When an image is halftoned each continuous tone pixel (capable of 256 levels of brightness or tone) is broken down into a pattern of single-brightness dots of ink. To account for the varying levels of brightness in the original image these patterns of ink dots, or screens, vary in either size or placement.

The practice of creating three-dimensional and animated images through the process of printing onto lenticular material can be quite complex in both the pre-press and on-press arenas. This practice is commonly plagued with technical difficulties, and the end results are often unsatisfactory. There is also a trend in the industry to move towards thinner and finer lenticular materials. This is driven by a desire to reduce overall manufacturing costs while at the same time increasing the potential applications of lenticular products. The challenge here is that as lenticular materials become thinner, there is also geometric growth in the technical difficulties inherent in the current state of reproduction methods.

Over the past several years various commercial lenticular software products have become available, and these programs all tend to address the creation of interlaced lenticular files. Traditionally, once interlaced images are created, they are brought into a pre-press environment where they are treated in the same manner as standard, non-interlaced files. While existing pre-press workflow and halftoning methods work very well with traditional, continuous-tone images, they introduce a host of problems and unnecessary complexities into the discipline of lenticular printing. These problems present themselves both in workflow convolution as well as visually in printed lenticular work in the form of moiré, banding, checkerboard patterning, ghosting, and blurry 3D images.

These visual problems have been addressed in several different ways with only limited levels of success. Most often what is attempted is to increase the fineness of the halftoning and printing processes, utilizing higher line screens and finer printing dots. An alternate method proposes the idea of half toning each component image separately prior to interlacing. While these methods often can result in better quality printing plates these ultra-fine dot plates introduce a whole new set of problems relating to putting unrealistic expectations on a printing press and its ability to reproduce such fine dot structures.

### BRIEF DESCRIPTION OF THE DRAWINGS

The above needs are at least partially met through provision of the method of producing improved lenticular images described in the following detailed description, particularly when studied in conjunction with the drawings, wherein:

FIG. 1 is a sample image;

FIG. 2 is a sample image;

FIG. 3 is a sample image;

FIG. 4 is an interlaced image made using the sample images of FIGS. 1 through 3;

FIG. 5 is a representation of a lenticular lens array with N component, interlaced images as configured in accordance with various embodiments of the invention;

FIG. 6 is a representation of an error diffusion process as configured in accordance with various embodiments of the invention;

FIG. 7 is a representation of an error diffusion process;

FIG. 8 is a representation of an error diffusion process as configured in accordance with various embodiments of the invention;

FIG. 9 is a representation of a halftoning process as configured in accordance with various embodiments of the invention;

FIG. 10 is a representation of an error diffusion process as configured in accordance with various embodiments of the invention;

FIG. 11 is a representation of a halftoning process as configured in accordance with various embodiments of the invention;

FIG. 12 is a representation of an asymmetric grid;

FIG. 13 is a representation of a the results of post-processing a halftoned image as configured in accordance with various embodiments of the invention;

FIG. 14 is a demonstration of a dither array halftoning process;

FIG. 15 is a representation of a dither array application to a multiplexed image;

FIG. 16 is a representation of the application of a dither array as shown in FIG. 15 for the image slices of two of the interlaced images;

FIG. 17 is three representations of grid arrangements as may be used in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Described herein is a process that dramatically improves the quality of spatially multiplexed images (hereafter referred to as interlaced images) for use in conjunction with lens arrays such as lenticular, fly's eye, square, hexagonal, triangular, and diamond packed configurations (hereafter referred to as “lenticular”). Before describing this process in more detail, however, it may be helpful to first briefly describe certain current practices. For example, take a project where the intent is to produce a lenticular effect, using a cylindrical lens array, where three different images ‘flip’ from one image to the next and to the next as the viewer turns the lenticular print in their hand.

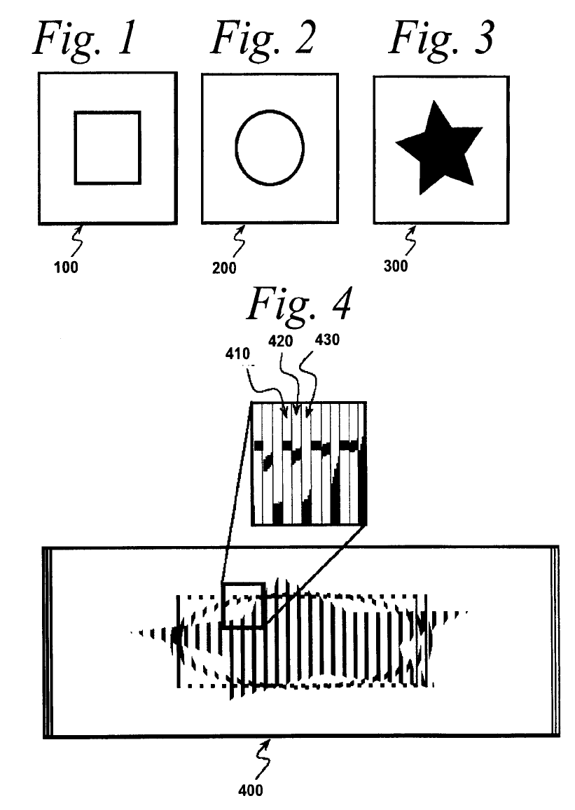

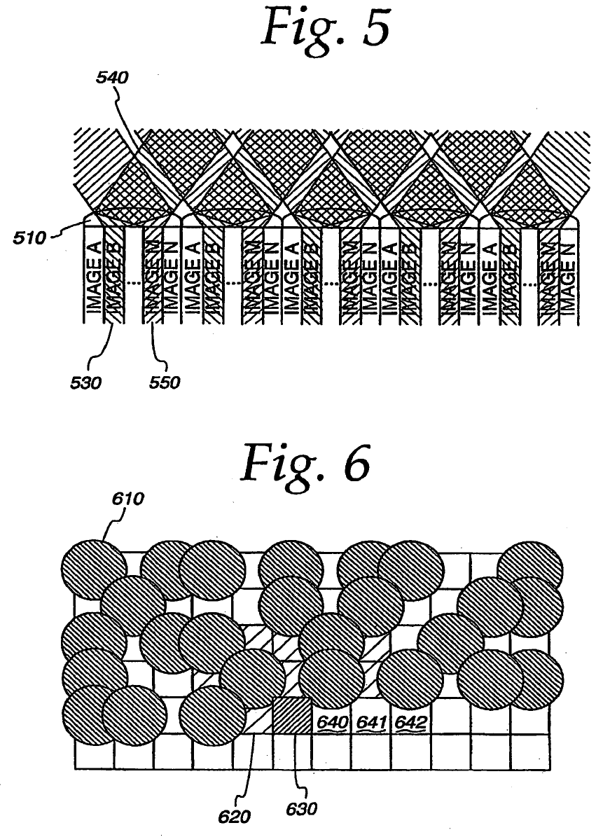

Given the images in FIG. 1, FIG. 2, and FIG. 3, an interlaced version of the figures would appear as shown in FIG. 4. The actual interlacing process is very straightforward and there are a number of software packages available that make simple work of it. This results in three strips of images (one strip per image per lens), 410, 420, and 430 for example, that need to be printed under each lenticular lens. FIG. 5 illustrates how lens 510 focuses the field of view from a certain angle 520 is focused on a particular image strip 530 whereas a field of view from a second angle 540 is focused on a another image strip 550. In the case of an interlaced image developed for use with a square-packed lenticular lens array substantially more images are necessary than for a cylindrical lenticular lens array.

Assuming the array is viewed with the lens axes vertically arranged, the screen forms an auto-stereoscopic (meaning an image where an illusion of depth is created without the use of glasses or other viewing device) array where each eye sees a unique image thus creating the illusion of depth. As such, the component images are typically of a 3-D scene viewed from a revolving angle. In other cases dissimilar images are used to create a flip or animation effect.

Generally speaking, pursuant to these various embodiments, an image comprising a plurality of interlaced images is provided, and the image is halftone processed according to one or more processes. The image is typically halftone processed at least in part according a predetermined function depending at least in part on a gray scale level for a given pixel and on gray scale levels for local pixels nearby the given pixel. The predetermined function can operate on a continuous tone version of the image or on a printed-dot model of the image. Alternatively, the predetermined function may include a predetermined error filter where halftoning error is distributed to pixels corresponding to the same interlaced image from which the error accumulates. The error may be capped at certain levels to avoid error build up. Also, the image may be mapped such that pixels from a given interlaced image are correlated with other pixels from the same interlaced image. Further, the image may be halftone processed according to a variety of printed dot models or dither arrays. Additionally, the image may be post-processed to arrange dots and/or shift columns of pixels to minimize overlap error. The image may also be modified to include extra pixels to align the interlaced images under the lenses. Once the image is processed and/or post processed, the image is printed onto a flat image of a lenticular or other lens array, or other secondary substrate, using an inkjet printer, for example.

Referring now to the drawings, and in particular to FIGS. 1-4, the image 400, including a plurality of interlaced images 100, 200, and 300, is provided and the image 400 is halftone processed at least in part on a gray scale level for a given pixel and on gray scale levels for local pixels nearby the given pixel. Because the image 400 is made up of the several interlaced images 100, 200, and 300, the image 400 is typically processed only in the context of the individual interlaced images 100, 200, and 300. Printers, however, will experience normal dot error and dot overlap along the boundaries between two given interlaced images. Thus, certain applications will address the effect of printing artifacts in the halftoning process as described in further detail below.

One method of halftoning the interlaced image is by applying error diffusion. In one such embodiment, the step of halftone processing the image is performed at least in part according to a predetermined function depending at least in part on diffusing error from a pixel corresponding to a first interlaced image to other pixels corresponding to the first interlaced image. When the predetermined function operates on a continuous-tone version of the image, error is defined as the difference between the brightness of a pixel in the halftoned image, either 0 for black (a dot is printed on the pixel) or 100 (or 1) for white (a dot is not printed on the pixel), and the brightness, which varies between 0 and 100, of the corresponding pixel in the continuous tone image from which the halftoned image is derived. Alternatively, the predetermined function may operate on a printed-dot model of the image, such as a printed-dot model for an inkjet printer, wherein the error is defined as the difference between the brightness of a pixel in the modeled image, which varies between 0 and 100, and the brightness of the continuous tone image. In either case, by distributing the error among pixels surrounding the pixel which is being processed, the brightness for a group of pixels in the halftoned image is approximately the same as the brightness of the same pixels in the continuous tone image.

The predetermined function may include a predetermined error filter that can be represented mathematically and stored in a computer memory where x[n] is the continuous tone image and y[n] is the halftoned image. Therefore, y[n] can be described as:

$$y [ n ] = \{ \begin{matrix}1 , & if ( x [ n ] + {x}_{e} [ n ] ) \geq 0 \\ 0 , & else\end{matrix}$$

where x_{c}[n] is the diffused quantization error accumulated during previous iterations of calculating the printed status of certain pixels. Thus, the error xₑ[n] can be represented by the equation:

$${x}_{e} [ n ] = {\sum }_{i = 1}^{M} {b}_{i} \cdot {y}_{e} [ n - i ]$$

with yₑ[n]=y[n]−(x[n]+xₑ[n]). The diffusion coefficients bᵢ, which regulate how the error at pixel n transfers or diffuses into neighboring pixels, are such that the sum of all bᵢ is 1. Computationally, error-diffusion can be done in-place with the output pixels, y[n], residing in the memory locations of the input pixels, x[n].

Noting that the printed dots of an ink-jet or similar printer can be accurately modeled as a binary, round, circular-dot such that an isolated black pixel is completely covered and portions of neighboring white pixels are partially covered, one skilled in the art will recognize that the binary halftones printed by error diffusion will always print darker than their ratio of printed to not-printed dots. As such, images will typically be tone-corrected prior to halftoning to compensate for this overlap. Alternatively, model-based error-diffusion, using for example an inkjet printer model, can account for dot overlap in the halftoning process where a model of the printed dot is used to predict the gray-level of each halftone pixel after printing and then using this modeled gray-level in the calculation of the corresponding quantization error.

In model-based error-diffusion, the output pixel, y[n], is still determined as defined above, but in this case, the error terms, yₑ[n−i] for i=1, 2, . . . , M, are calculated at each iteration and typically are not stored in an error image buffer. That is, assuming an ideal printer means that the quantization error, yₑ[n], can be diffused and stored in an error buffer, e[n], such that:

$$y [ n ] = \{ \begin{matrix}1 , & if ( x [ n ] + {x}_{e} [ n ] ) \geq 0 \\ 0 , & else ,\end{matrix} \\ where \\ {e}_{update} [ n ] = y [ n ] - ( x [ n ] + e [ n ] ) \\ and \\ {e}_{update} [ n = i ] = e [ n + 1 ] + {b}_{i} {e}_{update} [ n ] .$$

With reference to FIG. 6 using a dot model such as the hard circular-dot 610, which affects neighboring pixels indicated by lined box 620, means that the final value of y[n], 0 for printed or 1 for white or not printed, for the pixel 630 is not determined until all its neighboring pixels 620 have been quantized. So in model based error-diffusion, the error term, e[n], has to be calculated at each iteration prior to quantizing x[n]+e[n] as:

$$e [ n ] = {\sum }_{i = 1}^{M} {b}_{i} ( {y}^{′} [ n - i ] - x [ n - i ] )$$

where y′[n−i] is the modeled tone for output pixel y[n−i] assuming y[n+i] for i=1, 2, . . . are not printed as seen in the pixels 640, 641, and 642. From the above equations, model-based error-diffusion can be summarized as:

$$y [ n ] = \{ \begin{matrix}1 , & if ( x [ n ] + {\sum }_{i = 1}^{M} {b}_{i} ( {y}^{′} [ n - i ] - x [ n - i ] ) ) \geq 0 \\ 0 , & else .\end{matrix}$$

Various methods are known to predict and accurately model the resulting gray-levels that will be produced by a given printer for a given dot pattern. Such models can be specified by formulas, for example using the hard-circular dot model, or by table look-up where the table is generated by analysis of printed test patterns from the target device.

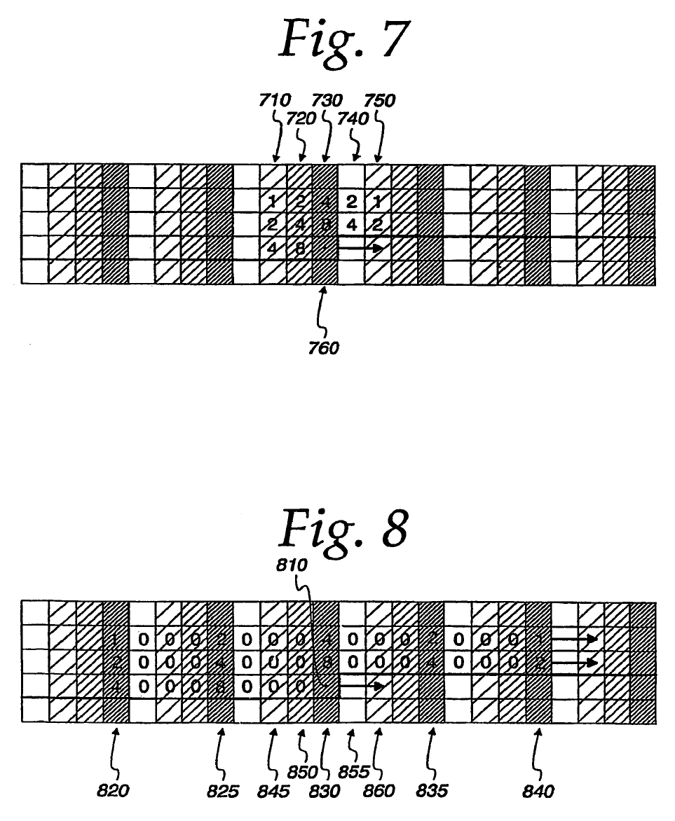

Although error-diffusion techniques are known to maximize a device's apparent resolution, the resulting halftone images are especially susceptible to distortion caused by print artifacts such as dot-gain and dot-loss due to their minimization of the perimeter-to-area ratio of printed dots. But more disconcerting for lenticular screening is the fact that as a neighborhood process, error-diffusion assumes correlation between neighboring pixels. In the case of a step-edge, error-diffusion will diffuse error across the edge to create a blurred edge in the halftone image. If the image is composed of multiple images spatially multiplexed together, with reference to FIG. 7, this blurring will typically result in columns of image slice 730 bleeding into slice 740. The overall impact of this bleeding depends on how well correlated the two slices are at the area of the blurring, but ghosting artifacts typically occur.

FIG. 7 shows a typical weighting of an error filter such that error from the currently processed pixel 760 is distributed to the nearby pixels in images 710, 720, 730, 740, and 750 according to the numerical weights 1, 2, 4, and 8 as indicated in the figure. The numerical weights are included in the mathematical representations in the constant bᵢ where the numerical weights as shown in FIGS. 7 and 8 represent relative weights. FIGS. 7 and 8 represent an example where four interlaced images are spatially multiplexed or interlaced with the slices corresponding to each image only a single pixel wide. As seen in an embodiment shown in FIG. 8, the error filters typically restrict the error from pixels of a given interlaced image to pixels corresponding to the same interlaced image by inserting an appropriate number of zero weights in-between the non-zero weights. Thus, the error from the processed pixel 810 will be distributed to pixels from image slices 820, 825, 835, and 840 that correspond to the same image as image slice 830, and zero weight is assigned to pixels of image slices 845, 850, 855 and 860, for example, of other interlaced images. The zero weights therefore minimize the effects of bleeding error between component interlaced images. The arrows of FIGS. 7 and 8 indicate the typical direction of processing the pixels.

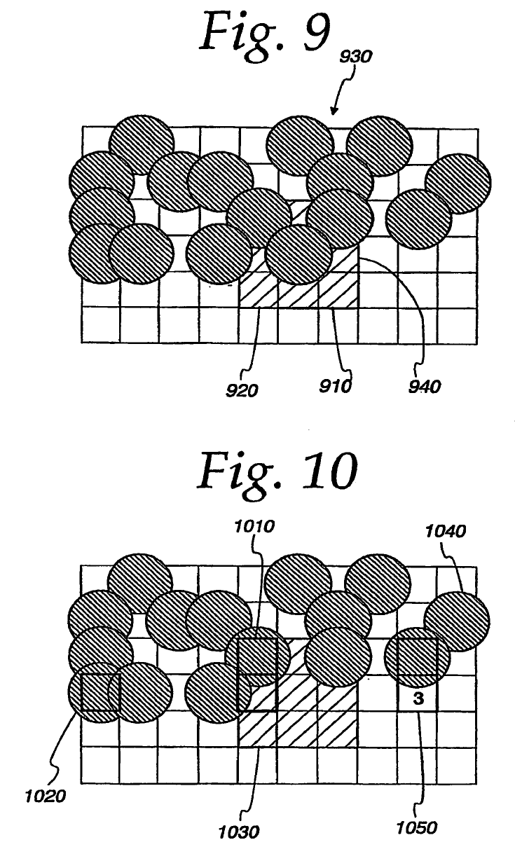

Alternatively and with reference to FIG. 9, the predetermined function for halftone processing the image may include a predetermined error filter depending on the gray scale levels of local pixels surrounding a given pixel for which error is being diffused. In one such embodiment, the halftoning step of determining whether a dot is printed is replaced such that a dot is printed if doing so reduces the mean-squared error between the modeled output and the accumulated image (input image with diffused error from previously processed pixels). More specifically, a first window indicated in gray 910, A[m, n], surrounding the modeled output pixel, y′[m, n], is segmented from the accumulated image xₐ[m, n]=x[m, n]+xₑ[m, n] along with a window W_{before}[m, n] from the modeled output image. W_{before}[m, n] represents the state of the modeled output without a printed dot 920 at y[m, n]. Placing a printed dot 920 at y[m, n], the modeled output image is updated with a new window W_{after}[m, n] segmented out. Choosing to keep a printed dot 920 at y[m, n] instead of removing it is determined by identifying which of the two windows, W_{before}[m, n] or W_{after}[m, n], has the lower mean-squared error when compared with A[m, n]. If W_{before}[m, n] has the lower error, then the printed dot 920 is removed from the halftoned image y[m, n] by updating the modeled output image; otherwise, the printed dot 920 is left in the halftoned image 930 and the process of diffusing the quantization error continues with the next pixel 940.

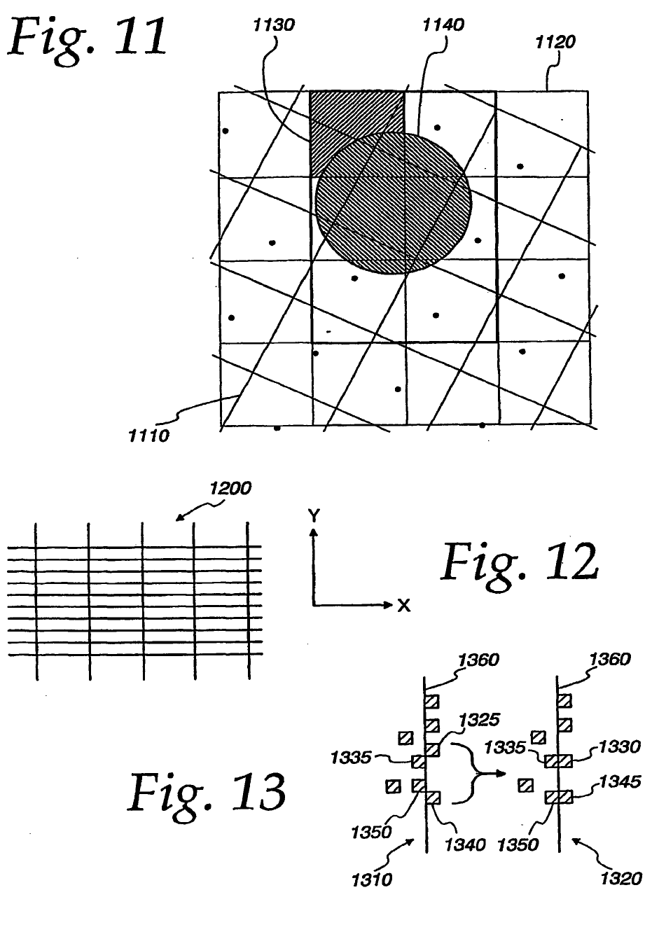

In a further alternative, the quantization error xₑ[m, n] of the currently processed pixel is not diffused into neighboring pixels; instead, the quantization error xₑ[m−1, n−1] of the top-left corner pixel 1010 is diffused into neighboring pixels 1020, 1030, 1040, and 1050 of the same interlaced image as the error diffused pixel 1010. In this embodiment, the computer may delete all memory of past input pixels preceding x[m−1, n−1]. Furthermore, this particular approach can be applied to problems where the sampling grid of the printer is not the same as the sampling grid of the continuous-tone, lenticular image. This particular situation is depicted in FIG. 11 where the pixel grids of the printer (diagonal lines) are indicated by reference numeral 1110, the original, continuous-tone image (horizontal and vertical lines) is indicated by reference numeral 1120, and the boundary of W_{before}[m, n] is indicated by a square bold, black line indicated by reference numeral 1130. The dark-gray circle 1140 models the area covered by a printed dot.

In certain embodiments, it is advantageous to perform the step of mapping the image such that an index corresponding to each pixel of a halftone processed version of a given interlaced image associates that pixel to other pixels of the halftone processed version of the given interlaced image. In such an embodiment, the index includes an indication of where each pixel of the halftone processed version of the given interlaced image is located relative to the other pixels of the halftone processed version of the given interlaced image. The pixels are typically indexed in memory such that the pixels are identifiable with their location indicator. Using such a mapping technique, minimum squared-error quantization error diffusion can be extended to arbitrarily arranged packed-lens arrays where error is diffused to the unprocessed pixels within a fixed sized neighborhood of the currently processed pixel having the same identification number/tag in the map image.

Alternatively, the mapping of the image can associate a depth indication to each pixel. The depth indication can include an indication of what portion of the image a given pixel occupies. For example, the depth indicator may indicate that a given pixel is located in the foreground portion of the image or the background portion of the image. Thus, an error filter may be applied according to the portion of the image from which the pixel originates to more efficiently distribute error to similar portions of the image.

For areas of the image where component images have similar gray-levels, the performance of model-based error-diffusion for lenticular images is consistent with traditional halftoning applications, but model-based error diffusion's performance is often poor in areas where the component images differ greatly in their gray-levels. For instance, the overlap of dots from dark-gray level slices into light gray-level slices limits the output gamut (in other words the range of color or brightness available) in the light-gray slices such that unregulated error builds up uncontrollably. The suppression of dots, caused by the unregulated build-up of error, is generally referred to as an instability, and it is known to clip the error build up across step-edges to reduce the amount of bleeding of the error across such discontinuities in gray-level.

More specifically, during halftoning in certain embodiments, the accumulated error is compared with the currently calculated pixel's brightness value, which after crossing a step-edge would jump in value. This jump in value would, likewise, create a jump in the amount of the accumulated error value, xₑ[n], relative to the input pixel brightness level, x[n], and trigger a clipping operation defined by the predetermined error threshold, T. Such clipping of the error beyond a such an error threshold (T=1.0, for example) may reduce some of the suppression of black, but it typically also exacerbates the problem of ghosting where the dark regions of one component image show up in neighboring component images. Thus, in certain embodiments, the predetermined function clips excess error from local pixels at a predetermined error threshold. Next, error amounts beyond the predetermined error threshold are diffused into nearby pixels, typically the nearest pixels of the neighboring component images. By doing so, we increase the gray-levels of the otherwise dark regions responsible for the instability and, thereby, alleviate the instability.

A further alternative approach to lenticular halftoning includes halftone processing the image at least in part by adjusting a gray scale level of a given pixel according to a predetermined function at least in part of a gray scale level of nearby pixels and probability values obtained from a lookup table (“LUT”). A typical embodiment involves applying traditional tone correction to the image of channel A and then adjusting the gray-levels of image B to account for dot-overlap from A. The gray-levels of channel C are then adjusted to account for overlap from both A and B as are all remaining channels to account for dot-overlap from the already processed channels. Once all the channels have been modified, the image of channel A is then updated to account for dot-overlap from its neighboring channels, which were ignored during the first iteration. With the update to channel A, all the remaining channels are then reprocessed to account for any changes, and this continues until the gray-levels of every channel finally converge. In this process, the predetermined function may brighten the gray scale of a given pixel to account for the dot overlap from nearby pixels. Similarly, the predetermined function typically brightens the gray scale of the pixels nearby the given pixel to account for the dot overlap from those nearby pixels.

In the case of the first channel, typically, a length-256 LUT is constructed where the i^{th} index is determined by halftoning a constant gray-level image with intensity (i−1)/255 and then inserting two, unprinted columns between every column of the pattern. The resulting pattern is then printed on the target device with the resulting print scanned in to a computer. The LUT entry is then set to the average gray-level of the printed columns corresponding to the printed pattern prior to up-sampling. In so doing, a tone correction curve (“TCC”) is built that ignores the impact of left and right dot overlap. Thus, from the original, spliced, continuous-tone image, an intermediate image is constructed where pixels corresponding to channel A and with gray-level g_{A} are set to the index value, g_{A(1)}, of the LUT with entry g_{A}.

Next, to adjust the pixels of the uncorrelated image B according to the predetermined function, one skilled in the art will understand that the probability that a given pixel of a binary, error-diffused dither pattern representing gray-level g is white (1) is equal to g. Extending this relationship to the printed page implies that the probability that a given point, y, is not covered by ink is equal to g′ where g′ is the measured gray-level of the printed pattern representing intensity g. An example where g′ will be different than g is in the case of the round, circular-dot model where the printed dot overlaps neighboring pixels.

For lenticular printing, the probability that a given point is covered by dots from its own channel and the probability that a given point is covered by dots of its neighboring channel are both of interest. The LUT used for processing image A is used for dots of the same channel. “LUT_{c}” will indicate this first LUT as where c stands for center. A second table is built for dots of the neighboring channel for measuring the likelihood of dot overlap by simply building a second table labeled LUTᵣ, where r stands for right and the table entry is the average gray-level of the pixel columns directly to the right of those used previously for LUT_{c}.

Given the two LUTs, the predetermined function can determine the probability that a given point, y corresponding to a pixel of image B, is not covered by ink is equal to the probability that y is not covered by a printed dot from image B and not from image A. Because these two events are uncorrelated, the probability that y is not covered by a dot from either channel is:

g_{B}=LUTᵣ(g_{A(1)})×LUT_{c}(g_{B(1)}),

where g_{B} is the desired gray-level of printed pixels in image B while g_{A(1)} and g_{B(1)} are the gray levels of the tone corrected images prior to halftoning. Because g_{A(1)} was determined previously when we processed image A, LUT_{c} is searched for the index with entry value g_{B(1)}, setting the pixels of the intermediate image accordingly. For modifying image C, we repeat the process used for image B where g_{B(1)} replaces g_{A(1)} and g_{c(1)} replaces g_{B(1)}. This process repeats until the last image (in our case, E) is to be processed, which is neighbored on both sides by already modified pixels.

For the last channel, it is assumed that printed dots are sufficiently small where dots of the left neighbor do not overlap dots of the right. Thus, in a favored embodiment, the predetermined function will divide the pixels of image E into two halves such that the above equation can be used to define the printed gray-level of each half of each pixel relative to its corresponding neighbor. The printed gray-level of the whole pixel is then defined according to:

g_{E}=½ [LUTᵣ(g_{D(1)})×LUT_{c}(g_{E(1)})]+½ [LUT_{c}(g_{E(1)})×LUT₁(g_{A(1)})]

=½LUT_{c}(g_{E(1)})×[LUTᵣ(g_{D(1)})+LUT₁(g_{A(1)})],

where LUT₁ is the table built by measuring the average gray-level for columns directly to the left of the error-diffused columns of our printed test patterns. Assuming symmetric dots, LUTᵣ can be used in place of LUT₁. Using this new equation, we can now update images A through E numerous times such that:

g_{A}=½LUT_{c}(g_{A(1)})×[LUTr(g_{E(i-1)})+LUTᵣ(g_{B(i-1)})],

where g_{A(i)} represents the new gray-level for pixels of image A after the ith iteration.

For programming purposes, the predetermined function can be simplified by setting g_{A(1)} through g_{E(1)} equal to their original gray-levels g_{A} through g_{E} and then initiating the process at g_{A(2)} thereby ignoring the first iteration. Although this process is described herein according to processing individual pixels on a pixel by pixel basis along a traditional left-to-right and then top-to-bottom raster scan, the algorithm should be not limited to processing all the pixels of one channel prior to addressing pixels of another. Furthermore, the algorithm allows channels to be processed in any order—not specifically with the left-most channel first. In other words, the pixels of the input image can be processed in any arbitrary order and not necessarily all at once or only once during a particular iteration.

One skilled in the art will understand that, although it is assumed that printed dots are sufficiently small such that dots from the left neighboring column do not overlap printed dots from the right neighboring column, when this is not the case the above described technique can be extended by increasing the number of LUTs needed to derive the expected gray-level of a given column. For instance, the given pixel typically is divided into three regions: (1) left region only overlapped by printed dots from the left neighbor, (2) center region overlapped by printed dots from both sides, and (3) right region only overlapped by printed dots from the right neighbor. As such, three LUTs are required with one LUT for each region of the pixel where the middle LUT is a two dimensional LUT indexed by the left and right side gray-levels.

One skilled in the art will also understand that, that the above discussion assumes that the formation of dots on the page follows an overlap model where a particular dot's size and shape is independent of the printed condition of its neighbors. For certain printers, such as an ink-jet printer, this assumption fails because tight clustering of printed dots increases the corresponding drying time. The increased drying time allows printed ink droplets to diffuse into and across the paper for a longer period of time, resulting in greater dot gain. For such embodiments, the above iterative tone correction process is modified to rely directly on table look-up to determine the best tone-corrected gray-level g_{A(i)} based upon the neighboring levels g_{E(i-1)} and g_{B(i-1)}.

More specifically, individual columns of binary pixels are selected from three separate printed patterns representing various gray-levels that are then spliced together as left, center, and right neighbors. The resulting three-column image is printed on the target device, scanned, and analyzed to measure the resulting average gray-level of the center column. This particular value along with those from all possible combinations of pixels will be used to build a three dimensional table. This table is indexed in the first dimension by the gray-level of the left-side neighbor g_{A(i)} and, in the second dimension, by the gray-level of the right-side neighbor g_{C(i-i)}. From that point, identifying the optimal g_{B(i)} amounts to searching through the LUT looking for the output tone nearest the target gray-level g_{B}.

To reduce the need for multiple iterations to reach convergence of the tone correction, alternatively, the predetermined function alternatively may use the gray-levels of the neighboring pixels directly to the left and right but of the previously processed row instead of the neighboring pixels directly to the left and right of the subject pixel. This process assumes that, at least, the first row was iteratively processed as described above for those rows to be properly tone corrected. In another alternative, the function may assume that pixels above the first row are white and that the resulting error quickly diminishes with each newly processed row. As a single-pass tone correction procedure, another alternative function would build a new look-up table based upon the previous LUT that is indexed by g_{B} instead of by g_{B(i)} such that the table need not be searched.

Viewing certain error diffused images created using the above LUT methods through common lenticular lenses creates a visual effect equivalent to down-sampling along the axis perpendicular to the alignment of the lenticular lens—creating aliasing artifacts in the pattern that result in low-frequency artifacts. These artifacts are then the source of visually disturbing textures that degrade the visual fidelity of the printed image.

In response to the down-sampling illusion created by the lenticular lenses, in certain alternative embodiments, it is advantageous to limit the width of the image slices to be only a single pixel wide after up-sampling to the printer's native resolution. If there are an insufficient number of component images by which to span the width of the lenses, one may perform the step of inserting pixels prior to halftone processing the image to allow for an approximately equal number of pixels from each interlaced image to correspond to a given lens may be performed to reduce artifacts created when the interlaced images do not correspond evenly with the lenses. One skilled in the art will recognize that this step may be performed on any lenticular image and that any number of pixels may be inserted to create additional columns or portions of images. New component images may be created by simply duplicating the existing images. Alternatively, it is possible to create these transition images by interpolating between existing, neighboring, component images. For example, gray levels for the inserted pixels may be derived from gray levels for pixels nearby the inserted pixels. Alternatively, the gray levels for the inserted pixels may be derived from the gray levels for pixels corresponding to an interlaced image corresponding to the inserted pixels. In addition, the inserted pixels may be removed after halftoning the image and prior to printing the image, thereby, generating an appropriately sized, binary image.

Following the procedure of creating new component images, the assumption of statistically independent columns is accurate; however, the assumption fails when using a traditional splicing technique because a given pixel may be correlated to its neighbors. The multiplicative relationship of the above described equations as used in the predetermined function is then no longer valid. In this alternative, the predetermined function applies an additive relationship defined by:

g_{B}=LUT_{r,s}(g_{A(1)})+LUT_{c}(g_{B(1)}),

is applied where LUT_{r,a} is a new look-up table representing the amount of dot coverage falling into the right-side neighboring columns of a printed dither pattern without up-sampling. Assuming symmetry, the same look-up table is used by the predetermined function for calculating overlap from both the right and left sides. Although the subscript E was previously used to indicate the gray-level was from the uncorrelated image E, here the subscript E uses it to signify the gray-level of left-side neighbor from the same image A just as the subscript B signifies the gray-level of the right-side neighbor also from image A. To extend the iterative tone correction to arbitrary lens arrays, the relationships of the above equations are used by the predetermined function for any and all pixels surrounding the currently processed pixel x[n] that may overlap x[n] if printed.

By using the iterative tone correction technique either as a multi or single pass procedure, the worst case errors occur when light gray pixels are surrounded by dark pixels—a phenomenon sometimes referred to as ghosting. In another alternative predetermined function, such instabilities can be detected using the above equation, rewritten as:

$${LUT}_{c} ( {g}_{A ( i )} ) = \frac{2.0 \times {g}_{A}}{{LUT}_{r} ( {g}_{E ( i - a )} ) + {LUT}_{r} ( {g}_{B ( i - 1 )} )}$$

where sufficiently small g_{E(i-1)} and g_{B(i-1)} with sufficiently large g_{A} leads to a ratio larger than 1.0, which is outside the range of LUT_{c}. As described above in connection with model-based error-diffusion, the excess intensity can be diffused into the neighboring, dark pixels to reduce the number of printed dots in these neighboring channels that overlap into the current channel.

More specifically, here error is defined as the excess intensity above a user-defined error threshold T where T is greater than 1. By using a separate threshold as opposed to the maximum reproducible intensity of 1, the drastic step of dampening neighboring gray-levels is limited to only particularly bad instances of instabilities. Assuming the threshold is crossed, typically, the error is distributed proportionally between the two sides of the subject column, especially in cases where the subject column is overlapped from only one side. To do so, the two halves of the subject pixel are analyzed separately, defining right eᵣ and left eₗ error terms as:

$${e}_{l} = \frac{{g}_{A}}{{LUT}_{r} ( {g}_{E ( i - 1 )} )} and {e}_{r} = \frac{{g}_{A}}{{LUT}_{r} ( {g}_{B ( i - 1 )} )}$$

Each half is then retested such that if e₁>T, then the gray-level corresponding to the left-side neighbor is modified as:

g′_{E}=g_{E}+αe₁,

or if eᵣ>T, then the gray-level corresponding to the right-side neighbor is modified as:

g′_{B}=g_{B}+αeᵣ,

where α is a second user-defined parameter that controls the rate at which light gray-levels are “burned” into neighboring dark levels. Given the iterative nature of the algorithm, even small values of α can have a significant effect, good and bad, depending on the number of iterations.

To simplify the conversion of the original, continuous-tone, lenticular image into a halftone image for printing, the predetermined function can incorporate the single-pass iterative tone correction procedure directly into error-diffusion. In particular, the quantization can be implemented as above except where xₑ[n] is the diffused quantization error accumulated during previous iterations as:

$${x}_{e} [ n ] = {\sum }_{i = 1}^{M} {b}_{i} \cdot ( \begin{matrix}y [ n - i ] - ( ITC ( x [ n - i - 1 ] , \\ x [ n - 1 ] , x [ n - i + 1 ] ) + \\ {x}_{e} [ n - i ] )\end{matrix} ) ,$$

where ITC(x[n−i—1], x[n−i], x[n−i+1]) is the iterative tone correction procedure that outputs the gray-level g_{A} as the target gray-level for the pixel x[n−i] such that, after printing, the corresponding printed pixel, y′[n−i], has the desired amount of ink coverage specified by x[n−i]. The terms x[n−i−1] and x[n−i+1] are not the pixels directly to the left and right of x[n] but the pixels directly to the left and right of the previously processed row, as specified for single-pass iterative tone correction.

Other alternative embodiments address the down-sampling visual artifacts discussed above that occur in certain lenticular images. For example and with reference to FIG. 12, the apparent sampling grid of a high quality printer as seen through the lenticular lens array typically forms a strongly asymmetric grid 1200 with many more pixels in the vertical direction y when compared to the horizontal direction x. In some cases, the apparent grid can appear to have 2,400 dots per inch vertical versus 100 dots per inch horizontal. As such, a halftoning scheme which operates well in traditional printing applications may lead to visually disturbing textures for lenticular applications. Thus, according to various embodiments, the image may be halftone processed at least in part according to a predetermined function depending at least in part on a human visual system model. Such a model typically takes includes a model, such as a printed-dot model for an inkjet printer, of printed pixels of the image accounting for lens related visual artifacts. For example, the model may include an asymmetric sampling grid as seen through the lens array. As such, the most typical optimal lenticular halftoning algorithms are the ones that take into account the asymmetry of the apparent sampling grid and try to maintain a radially symmetric, fixed, average separation between minority pixels. In the case of a lenticular image where the lens' axes are arranged vertically, this means placing printed dots closer together (in units of pixels/samples) along the horizontal than the vertical. This also implies that printed dots should be more likely to occur side by side one another than to be printed one directly above the other. It is this same feature of the human visual system and asymmetric grids that justifies using amplitude modulated (“AM”) line screens running perpendicular to the lens axes with the dots placed closely together in the direction perpendicular to the lens axes.

For frequency modulated (“FM”) halftoning by means of error-diffusion, there are several means by which increased horizontal correlation between printed dots can be achieved. One such embodiment includes halftone processing the image at least in part according to a predetermined function depending at least in part on a threshold variable for a given pixel that is responsive at least in part to a printed status of nearby pixels of the image. Such threshold modulation, typically includes modulating the quantization threshold to increase or decrease the likelihood of printing a dot. For example, intermediate halftone image, h_{T}[n], is derived by x[n], using a traditional halftoning technique such as an AM line screen. From h_{T}[n], we then modulate the threshold of our iterative-tone correction error-diffusion technique such that:

$$y [ n ] = \{ \begin{matrix}1 , & if ( x [ n ] + {x}_{e} [ n ] ) \geq 0 - α {h}_{T} [ n ] \\ 0 , & else\end{matrix}$$

where α is a tuning parameter controlling how much influence we want h_{T}[n] to have on the placement of dots in y[n]. An alternative means by which added directional correlation can be achieved is through error modulation whereby the output pixel is derived according to:

$$y [ n ] = \{ \begin{matrix}1 , & if ( x [ n ] + α {h}_{T} [ n ] \times {x}_{e} [ n ] ) \geq 0 \\ 0 , & else\end{matrix}$$

where it is now the error term xₑ[n] that is being manipulated by the intermediate halftone h_{T}[n].

Another alternative includes adding directional correlation through threshold modulation whereby the output pixel is derived according to:

$$y [ n ] = \{ \begin{matrix}1 , & if ( x [ n ] + {x}_{e} [ n ] ) \geq 0 + α \times x [ n + / - i ] \\ 0 , & else\end{matrix}$$

where x[n+/−i] represents the intensity value of a pixel within a local neighborhood of x[n], specifically from the neighboring component image. For the above threshold modulation methods, one will recognize that the printed status of the nearby pixels may be determined at least in part on a lookup table of printed status probabilities or on a predetermined non-linear function of the gray scale levels of nearby pixels.

One skilled in the art will recognize that the use of horizontal correlation in a given human visual system model assumes a lenticular lens array where the lens axes are arranged vertically. An important feature is that the distribution of printed dots attempts to counter the effects of the apparent, asymmetric sampling grid of the printer as seen through the lens array. Thus, in the case where the lens axes are arranged horizontally, the human visual system model would include a vertical correlation between printed dots.

For an arbitrary lens array, another alternative for the predetermined function depending on a human visual system model includes an error diffusion process dependant at least in part on the human visual system model. Such an error diffusion process may modify the error filter weights, signified by bᵢ, such that the resulting distribution of pixels counters the asymmetric sampling grid to create a visually pleasing halftone when seen through the lens array. Typically, the resulting error filter will only minimize low-frequency graininess across a small range of gray-levels. It is known that certain error filters will perform better for a given graininess or frequency within an image. Therefore, the image may be halftone processed according to the frequency content in the image. One such embodiment may include multiple error filters for all ranges of gray-level such that the specific error filter used to distribute the error for a pixel is determined according to the continuous-tone gray-level of the pixel. For example, one may use stochastic halftoning for areas of the image with a high frequency content and use period halftoning for areas of the image with a low frequency content. Typically, stochastic halftoning is used for gray levels of 0% to about 29% and about 71% to 100% whereas period halftoning is used for mid-gray levels of about 30% to about 70%. Another embodiment may include assigning for each pixel a value corresponding to a variation in gray scale among nearby pixels.

In such an embodiment, a library of error filters is stored in memory. Such an approach typically also requires optimizing the error filter weights at each gray-level by generating a spatial or spectral cost function assessed on the resulting dither pattern created by a particular error filter. This error filter is then modified in some manner such that the next iteration of error filter has a lower cost function than the previous. Repeating this process for many iterations typically would then converge on a final error filter stored in memory and used when halftoning the corresponding gray-level.

An alternative technique for measuring the visual cost of a particular dither pattern is to generate a human visual model that models the visibility of a given pattern as a radially symmetric low-pass filter. While diagonal correlation has been used to modulate such a human visual system model along the diagonals of the power spectrum, the total amount of modulation was small. For arbitrary lens arrays, the human visual system model addresses the asymmetry in the apparent sampling grid, placing printed dots closer along some axes and farther apart along others. The specific shape of the filter will depend on the distribution of lenses.

A further alternative embodiment for halftone processing the image includes the step of post-processing the image by changing a printed status of at least one pixel to increase the likelihood of printing on adjacent pixels. This process is also called a direct binary search wherein the halftoned image is reviewed and the printed status of a given pixel is changed based upon the printed status of nearby pixels. For example, having an human visual system model for asymmetric grids, the pixels of the halftone image are processed iteratively where during a particular iteration, a printed dot is either swapped with a neighbor, toggled from on to off or off to on, or left unchanged depending upon which transformation leads to a lower visual cost or reduced artifacts between the current halftone image and the original, continuous-tone image.

This process is illustrated in FIG. 13 where a halftoned image is shown before 1310 and after 1320 post-processing. The printed pixel 1325 is toggled off or shifted to a new position 1330 in the post-processed image 1320 to align with printed pixel 1335. Similarly, the printed pixel 1340 is toggled off or shifted to a new position 1345 in the post-processed image 1320 to align with printed pixel 1350. Thus, by arranging printed pixels next to each other, potential error from dot overlap across the boundary 1360 is lessened.

The problem for direct binary or pixel search for lenticular/lens array images is that the associated human visual system model assumes a monocular view of the halftone. Thus, a better pixel search embodiment includes a vision model that processes printed dots according to a cost function for both a monocular as well as a binocular component such that printed dots from the left eye image are matched with printed dots from the right eye image. More specifically, printed dots from two component images, which are closely spaced when viewed through the lens array, may appear to be floating in space due to the stereoscopic effect of lens array images. As such, the depth at which the points appear to be positioned may not be consistent with the depth plane of the image content, and as the points get farther and farther away from the depth plane of intended image content. The pixel post-processing step can address this effect by taking into account the shape of the lens.

A further embodiment of the process using the human visual model may include an output dependent feedback mechanism. In such an embodiment wherein the error filter using the human visual system model measures error in terms of both the monocular halftone texture as well as the binocular, the stereoscopic texture can be optimized by modifying the weights of error diffusion with output dependent feedback where the output pixel y[n] is defined as:

$$y [ n ] = \{ \begin{matrix}1 , & if ( x [ n ] + {x}_{e} [ n ] ) \geq 0 + h {\sum }_{j = i}^{M} {a}_{j} y [ n - j ] \\ 0 , & else\end{matrix}$$

where

$$h {\sum }_{j = i}^{M} {a}_{j} y [ n - j ]$$

where is the weighted sum of previous output pixels. Setting the tuning parameter h at a high level has the effect of increasing the likelihood that y[n] results in a printed dot while setting h at a low level has the effect of decreasing the likelihood. Properly tuned, the above process can produce visually pleasing lens array halftones that minimize low-frequency graininess in the component images, when viewed independently, as well as when two component images are viewed stereoscopically.

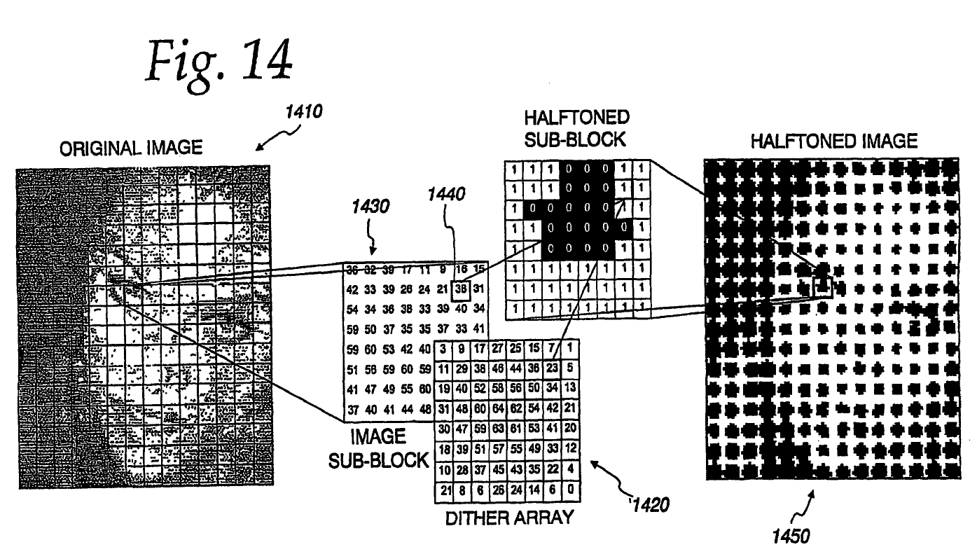

Dither array halftoning, as known in the art and with reference to FIG. 14, refers to a technique whereby the pixels of a continuous-tone, original image 1410 are compared with a predetermined quantization threshold number stored in a secondary matrix 1420 such that pixels with gray-levels larger in value to their corresponding threshold are printed, while those with gray-levels less than their threshold are not printed. This secondary matrix 1420 is referred to as the dither array 1420 or, sometimes, mask. Typically, these dither arrays are small (16×16, 32×32, . . . , 256×256 for example) compared to the original image to be halftoned (2,400 pixels per inch), and as such, the dither array is tiled end-to-end to create larger dither arrays such that for each pixel in the original image, there exists a single threshold within the mask. For example, the image sub-block 1430 includes a plurality of pixels showing the brightness value of each pixel such as 38 for the indicated pixel 1440. The brightness level of the pixel 1440 is greater than the corresponding pixel of the dither array 1420; therefore, no dot is printed at that pixel in the halftoned image 1450.

With regards to lenticular halftoning, proper halftoning of the spatially multiplexed, continuous tone image should be performed such that intersection of the dither array with the pixels of a particular component image leads to a uniform distribution of all possible threshold levels from the minimum to the maximum intensity level. This uniform distribution should also be done in as small a local neighborhood as possible. Specifically in traditional halftoning, a 16×16 dither array should have, for an 8-bit per pixel grayscale image, 256 unique thresholds ranging from 0 to 255. As such, an image of constant gray-level g should be printed such that, for every 16×16 window, the ratio of the number of printed pixels to the total number of pixels inside the window is equal to g. Those skilled in the art will recognize the needed modifications to account for printer variability.

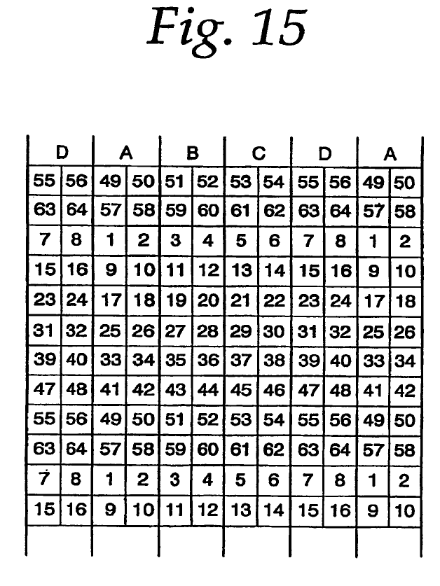

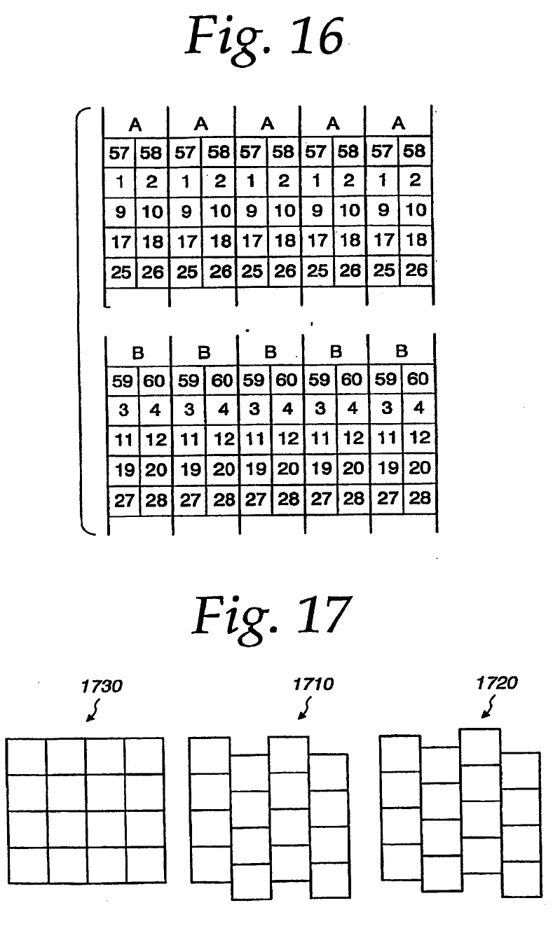

Thus, applying that same 16×16 dither array to a lenticular image where each slice of each component image was composed of two consecutive image columns, then only those thresholds within two consecutive columns would be applied to a particular channel. Assuming that the thresholds within the 16×16 were labeled Tᵢ for i=1, 2, . . . , 256, then threshold T₁ would be applied to one channel but not to either the left or right side neighboring channel. This process is demonstrated in FIG. 15 where we show the distribution of thresholds for an 8×8 dither array and a lenticular image composed of component images (channels), each two pixels wide. FIG. 16 shows just the distribution of dither array thresholds of the first and second most left channels as they would appear through the lenticular lens array, where we de-multiplexed the component images. As can be seen, the dither array thresholds are not evenly distributed between component images.

Thus, another alternative for halftoning the image includes halftone processing the image according to a plurality of interlaced dither arrays. For example, assuming that N interlaced images comprise the single, continuous-tone, arbitrary lens array image, a series of techniques are available by which N separate dither arrays are interlaced or spatially multiplexed in a fashion corresponding to the interlacing or multiplexing used to create the lens array image to be halftoned. In such an embodiment, the resulting dither array can be tiled end-to-end where thresholds of the nth dither array are in alignment with the pixels of the nth component image. Alternatively, each of the N dither arrays may be of different sizes, and as such, we may tile each dither array end-to-end in order to create N separate images, each the same size as their corresponding component image prior to spatial multiplexing, and then spatially multiplexing these super dither arrays into a single dither array the same size as the original, continuous-tone, arbitrary lens array image.

As one approach to this lens array halftoning technique, N component dither arrays are generated from a single dither array by simple replication. Alternatively, one can transform one of the component dither arrays after replication by means of a rotation, flip, inversion, circular shift, or any combination there of. This is an especially advantageous approach when using a pseudo-random dither array as one of these transformations will lead to an uncorrelated appearance between component images while being able to store only the original dither array in memory. A specific example of this latter approach is to use a traditional AM line screen for the odd numbered channels, and the same dither array after a horizontal flip. As another approach to dither array halftoning, the N component dither arrays can be derived as N independently generated dither arrays. Finally, some combination of independently and replicated dither arrays is also possible.

With reference to FIG. 17, yet another alternative method of halftone processing the image includes at least in part shifting a set of pixels by a predetermined distance relative to nearby pixels. Typically, a column of pixels is shifted by one-half of a pixel dimension to create a hexagonal pattern 1710, but other shifting may be done as shown in the arbitrary grid 1720. Certain methods of halftoning, including for example green noise halftoning, can unlock a host of advantages commonly associated with hexagonal sampling grids 1710 where hexagonal (also known as “quincuncial”) grids 1710 differ from rectangular grids 1730 in that every other row is offset one-half pixel period. In particular, hexagonal sampling grids 1710 allow a more natural radially symmetric sampling of two dimensional space—preserving a circular band-limited signal with only 86% of the total number of samples used by rectangular grids 1730. Additional advantages to hexagonal sampling grids 1710 over rectangular grids 1730 are their robustness to changes in aspect ratio. The aspect ratio is the horizontal period divided by the vertical period while the pixel shapes are defined by the perpendicular bi-sectors between neighboring pixels.

The best case covering efficiency for rectangular grids 1730 occurs for square grids, whereas hexagonal grids 1710 outperform rectangular grids 1730 over a wide range of aspect ratios, in some cases by over an order of magnitude. This allows for resolution to be increased asymmetrically yet still enjoy superior radial symmetry of pixel coverage. It is very often easier to increase resolution in only one dimension, and using hexagonal grids 1710 provide such an opportunity. In the case of model-based error-diffusion, hexagonal grids 1710 have an advantage in that a given pixel has only six directly neighboring pixels instead of eight; furthermore, the model of overlap for a hard-circular dot is symmetric for all neighboring pixels. As such, non-traditional sampling grids such as the hexagonal sampling grid 1710 may provide significant advantages over rectangular grids 1730 for lenticular printing. Hexagonal grids 1710 are also the preferred sampling technique for non-lenticular lens arrays such as, in particular, hexagonal lens arrays.

Given the super-high dot addressability of modern digital printers, the implementation of hexagonal grid halftoning is reasonable for, at least, a hand-full of devices (eletrophotographic printers, in particular), and given the general advantages to using hexagonal sampling grids. By studying the application of blue and green-noise to images sampled along hexagonal grids, it has been determined that at a specific degree of coarseness, hexagonal sampling grids are the preferred sampling technique for stochastic dithering.

In describing the various approaches to halftoning, a third class of techniques is referred to as AM-FM hybrids because they combine the concepts of varying dot size and dot frequency with variations in gray-level. Extending these concepts to lenticular printing, the image may be halftone processed according to a frequency content in the image. For example, variations in the manner in which print dots are distributed based upon the change in image content between component images in the continuous-tone, lenticular image may be considered a shift in the frequency of dot placement within the image. More specifically, the statistical independence between printed dots from neighboring component images is maintained when the variation in tone, in other words the frequency content, between those component images is high while strongly correlating dot placement in regions where tonal variations between component images are small. Such an embodiment may be considered an alternative to the library of error filters dependent on the graininess of the image as discussed above.

In one alternative approach, the N component images are assumed to be separate views of a three dimensional scene such that the statistical correlation in color between neighboring pixels of the interlaced image varies according to the disparity in depth between the objects within the fields of view of the two pixels. As such, a depth image can be maintained such that a pixel of this image, d[n], stores the apparent depth coordinate of the image content stored in pixel x[n] of the continuous tone, lenticular image as discussed above. Then the depth value between two neighboring pixels may be used as a means for manipulating the correlation between the printed dot status of the two corresponding pixels of the lens array halftone. As an example, the predetermined function may use the inverted, normalized difference in depth, 1−|d[n]−d[n−1]|/(dₘₐₓ−dₘᵢₙ), as the value of a in the above equation regarding threshold modulation. Alternatively, a difference image may be generated from the depth image that can be run through a low-pass filter, using the filtered output in place of |d[n]−d[n−1]| for defining α.

Instead of using depth as a measure of statistical dependence between neighboring pixels of the continuous-tone, lens array image, alternatively, the gray-levels of the pixels may be used by means of a difference image with pixel x[n] being equal to |x[n]−x[n−1]|. As such, the difference image may be run through a low-pass filter such that the energy from x[n] is spread into the local, surrounding neighborhood. The resulting low-pass filtered image is then utilized in the threshold modulation equations.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method to facilitate preparing an image comprising a plurality of interlaced images for printing, comprising:
providing the image;
halftone processing the image at least in part according to a predetermined error filter depending at least in part on a gray scale level for a given pixel and on gray scale levels for local pixels nearby the given pixel; and
printing the image using an inkjet printer after processing the image.

2. A method to facilitate preparing an image comprising a plurality of interlaced images for printing, comprising:
providing the image;
halftone processing the image at least in part according to a predetermined function depending at least in part on diffusing error from a pixel corresponding to a first interlaced image to other pixels corresponding to the first interlaced image; and
printing the image using an inkjet printer after processing the image.

3. The method of claim 2 wherein the predetermined function includes a predetermined error filter.

4. The method of claim 3 wherein the predetermined error filter depends at least in part on a gray scale level of a given pixel.

5. The method of claim 3 wherein the predetermined error filter depends at least in part on gray scale levels of local pixels surrounding a given pixel for which error is being diffused.

6. A method to facilitate preparing an image comprising a plurality of interlaced images for printing, comprising:
providing the image;
halftone processing the image at least in part according to a predetermined function depending at least in part on a threshold variable for a given pixel that is responsive at least in part to a printed status of nearby pixels of the image; and
printing the image using an inkjet printer after processing the image.

7. The method of claim 6 wherein the printed status is determined at least in part on a lookup table of printed status probabilities.

8. The method of claim 6 wherein the printed status is determined at least in part on a predetermined non-linear function of the gray scale levels of nearby pixels.

9. A method to facilitate preparing an image comprising a plurality of interlaced images for printing, comprising:
providing the image;
halftone processing the image at least in part according to a predetermined function depending at least in part on a human visual system model comprising a printed-dot model for inkjet printers that models printed pixels of the image accounting for lens related visual artifacts; and
printing the image using an inkjet printer after processing the image.

10. The method of claim 9 wherein the printed-dot model for inkjet printers that models printed pixels of the image accounting for lens related visual artifacts further comprises an asymmetric sampling grid as seen through a lens array.

11. The method of claim 10 wherein the asymmetric sampling grid as seen through a lens array further comprises modeling the printed pixels as closer together in certain axes in relation to other axes in relation to the lens array.

12. The method of claim 9 wherein the predetermined function further comprises an error diffusion process dependant at least in part on the human visual system model.

13. The method of claim 12 wherein the human visual system model further comprises a printed-dot model for inkjet printers that models printed pixels of the image accounting for lens related visual artifacts.

14. The method of claim 13 wherein the printed-dot model that models printed pixels of the image accounting for lens related visual artifacts further comprises an asymmetric sampling grid as seen through a lens array.

15. A method to facilitate preparing an image comprising a plurality of interlaced images for printing, comprising:
providing the image;
halftone processing the image;
post-processing the image by changing a printed status of at least one pixel to increase the likelihood of printing on adjacent pixels; and
printing the image using an inkjet printer after post-processing the image.

16. A method to facilitate preparing an image comprising a plurality of interlaced images for printing, comprising:
providing the image;
halftone processing the image at least in part by adjusting a gray scale level of a given pixel according to a predetermined function at least in part of a gray scale level of nearby pixels and probability values obtained from a lookup table; and
printing the image using an inkjet printer after processing the image.

17. The method of claim 16 wherein the predetermined error filter depends at least in part on a probability of printing at the given pixel and at the nearby pixels.

18. The method of claim 16 wherein the predetermined error filter depends at least in part on a printed status of the nearby pixels.

19. The method of claim 16 wherein the predetermined function further comprises brightening the gray scale level of the given pixel to account for dot overlap from nearby pixels.

20. The method of claim 16 wherein the predetermined function further comprises brightening the gray scale level of pixels nearby the given pixel to account for dot overlap from the nearby pixels.

21. A method to facilitate preparing an image comprising a plurality of interlaced images for printing, comprising:
providing the image;
halftone processing the image at least in part by shifting a set of pixels by a predetermined distance relative to nearby pixels; and
printing the image using an inkjet printer after processing the image.

22. A method to facilitate preparing an image comprising a plurality of interlaced images for printing, comprising:
providing the image;
halftone processing the image to create a first halftone image;
halftone processing the image at least in part by adjusting a gray scale level of a given pixel according to predetermined function at least in part of a gray scale level of nearby pixels and probability values obtained from a lookup table, at least in part by diffusing error from the given pixel corresponding to a first interlaced image to other pixels corresponding to the first interlaced image, and at least in part by applying a plurality of quantization thresholds according to a predetermined function of the first halftone image; and
printing the image using an inkjet printer after processing the image.

23. A method to facilitate preparing an image comprising a plurality of interlaced images for printing, comprising:
providing the image;
halftone processing the image according to a plurality interlaced dither arrays wherein each of the plurality of interlaced dither arrays corresponds to one of the interlaced images; and
printing the image using an inkjet printer after processing the image.

24. The method of claim 23 wherein each of the plurality of interlaced dither arrays further comprises a modification of a dither array wherein the modification comprises any one of the group comprising: rotation, inversion, spatial shifting, horizontal mirroring, and vertical mirroring.

25. A method to facilitate preparing an image comprising a plurality of interlaced images for printing, comprising:
providing the image;
halftone processing the image according to a frequency content in the image; and
printing the image using an inkjet printer after processing the image.

26. The method of claim 25 wherein the step of halftone processing the image according to a frequency content in the image further comprises assigning for each pixel a value corresponding to a variation in gray scale among nearby pixels.

27. The method of claim 25 wherein the step of halftone processing the image according to a frequency content in the image further comprises using stochastic halftoning for areas of the image with a high frequency content and using period halftoning for areas of the image with a low frequency content.

28. A method to facilitate preparing an image comprising a plurality of interlaced images for printing, comprising:
providing the image;
halftone processing the image according to a gray scale level of a given pixel such that the given pixel is processed using stochastic halftoning for gray levels of 0% to about 29% and about 71% to 100% and using period halftoning for mid-level gray levels of about 30% to about 70%; and
printing the image using an inkjet printer after processing the image.

29. A method to facilitate preparing an image comprising a plurality of interlaced images for printing, comprising:
providing the image;
inserting pixels prior to halftone processing the image to allow for an approximately equal number of pixels from each interlaced image to correspond to a given lens;
halftone processing the image with inserted pixels; and
printing the image using an inkjet printer after processing the image.

30. The method of claim 29 wherein the step of inserting pixels prior to halftone processing the image to allow for an approximately equal number of pixels from each interlaced image to the given lens further comprises deriving a gray level for the inserted pixels from gray levels for pixels nearby the inserted pixels.

31. The method of claim 29 wherein the step of inserting pixels prior to halftone processing the image to allow for an approximately equal number of pixels from each interlaced image to the given lens further comprises deriving a gray level for the inserted pixels from gray levels for pixels corresponding to an interlaced image corresponding to the inserted pixels.

32. The method of claim 29 further comprising:
removing the inserted pixels after halftoning the image and prior to printing the image.
